(19) United States
(12) Patent Application Publication
(10) Pub. No.: US 2015/0369457 A1
(43) Pub. Date: Dec. 24, 2015

(54) Light-Emitting Device

(71) Applicant: EPISTAR CORPORATION, Hsinchu (TW)

(72) Inventors: Keng-Chuan CHANG, Hsinchu (TW); Chiu-Lin YAO, Hsinchu (TW)

(21) Appl. No.: 14/312,377

(22) Filed: Jun. 23, 2014

(51) Int. Cl. F21V 19/00; F21V 23/00; F21V 3/00; F21V 5/04; F21V 23/06

(52) U.S. Cl. CPC F21V 19/001; F21V 5/04; F21V 23/06; F21V 3/00; F21V 23/005; F21Y 2101/02

(57) ABSTRACT

A light-emitting device disclosed herein comprises an integrated board having a first part and a second part form an angle other than zero with the first part and a light-emitting element disposed on the first part.

### TECHNICAL FIELD

The application relates to a light-emitting device, and more particularly, to a light-emitting device comprising an integrated board having a first part and a second form an angle other than zero with the first part.

### BACKGROUND OF THE DISCLOSURE

The light-emitting diodes (LEDs) of the solid-state lighting elements have the characteristics of the low power consumption, low heat generation, long operational life, shockproof, small volume, quick response and good opto-electrical property like light emission with a stable wavelength so the LEDs have been widely used in household appliances, indicator light of instruments, and opto-electrical products, etc.

### SUMMARY OF THE DISCLOSURE

A light-emitting device comprises an integrated board having a first part and a second part form an angle other than zero with the first part, and a light-emitting element disposed on the first part.

A method for manufacturing a light-emitting device comprises providing an flexible integrated board, deflecting the flexible integrated board such that two parts of the flexible integrated board on opposite sides of a deflected region form an angle other than zero, forming a light-emitting element on one of the two parts of the flexible integrated board, and forming a circuit element on another of the two parts of the flexible integrated board.

### BRIEF DESCRIPTION OF THE DRAWINGS

FIG. 1A illustrates a light-emitting device in accordance with first embodiment of the present disclosure.

FIG. 1B shows a cross-section along line A-A of FIG. 1A

FIG. 1C shows an exploded view of FIG. 1A.

FIG. 2A illustrates an integrated board with a plurality of light-emitting elements of a light-emitting device in accordance with first embodiment of the present disclosure.

FIG. 2B illustrates an integrated board with a first circuit element of a light-emitting device in accordance with first embodiment of the present disclosure.

FIG. 2C illustrates an integrated board with a connecting board and a second circuit element of a light-emitting device in accordance with first embodiment of the present disclosure.

FIG. 2D illustrates an integrated board jointing a connecting board of a light-emitting device in accordance with first embodiment of the present disclosure.

FIGS. 3A-3G illustrate a fabricating method of a light-emitting device in accordance with the first embodiment of the present disclosure.

FIG. 4 illustrates a cross-section of a light-emitting element of a light-emitting device in accordance with the first embodiment of the present disclosure.

### DETAILED DESCRIPTION OF THE PREFERRED EMBODIMENTS

The embodiment of the application is illustrated in detail, and is plotted in the drawings. The same or the similar part is illustrated in the drawings and the specification with the same number.

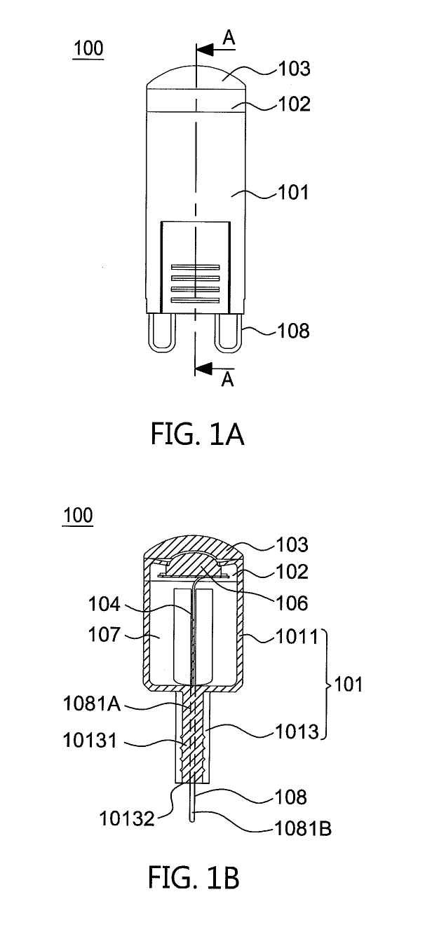

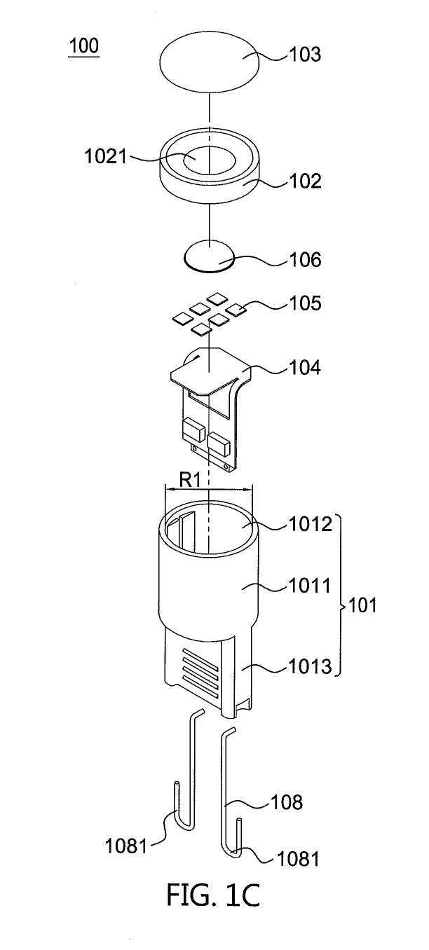

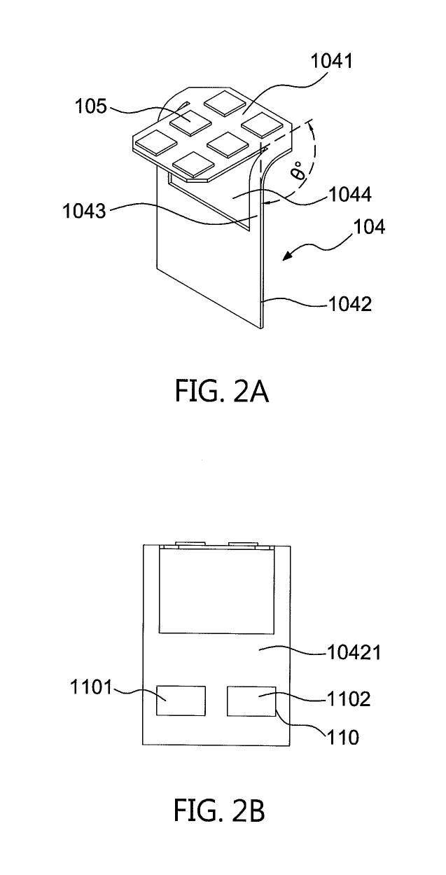

FIGS. 1A˜1C illustrate a light-emitting device 100 in accordance with first embodiment of the present disclosure, wherein FIG. 1B shows a cross-section along line A-A of FIG. 1A and FIG. 1C shows an exploded view of FIG. 1A. As shown in FIG. 1A, the light emitting device 100 comprises a housing 101, a fastener 102 arranged on the housing 101, a lens 103 arranged on the fastener 102 and an electrically connecting element 108 connecting to the housing 101. As shown in FIGS. 1B-1C, the light emitting device 100 further comprises an integrated board 104, a plurality of light-emitting elements 105 arranged on the integrated board 104 and surrounded by the fastener 102, and a cover 106 covering the plurality of light-emitting elements 105. In the present embodiment, the housing 101 has a body 1011, a space 1012 within the body 1011 and a base 1013 narrower than the body 1011, extending from the body 1011 and having a through-hole 10131. The integrated board 104 is arranged in the body 1011 and surrounded by the body 1011, wherein the integrated board 104 has a width W1 smaller than or equal to an internal diameter R1 of the base 1011. The fastener 102 covers the integrated board 104 and has an opening 1021 exposing the cover 106. The lens 103 covers the fastener 102 and the cover 106. The light emitting device 100 further comprises a filler 107 filling the space 1012 of the housing 101, wherein the integrated board 104 is wrapped by the filler 107. The electrically connecting element 108 passes through the through-hole 10131 of the base 1013 and a bottom 10132 of the base 1013, wherein the electrically connecting element 108 has two pins. Thus, a first part 1081A of the pins 1081 is surrounded by the base 1013 and a second part 1081B of pins 1081 extends out of the base 1013, so that the second part 1081B of pins 1081 may electrically connect to the external power supply (not shown). The filler 107 comprises a thermally conductive material and the housing 101 comprises a plastic material, such as ABS; thermally conductive plastic material, such as plastic material with graphite or ceramic powder; ceramic or casting aluminum.

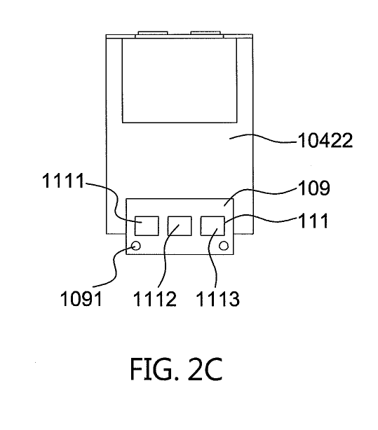

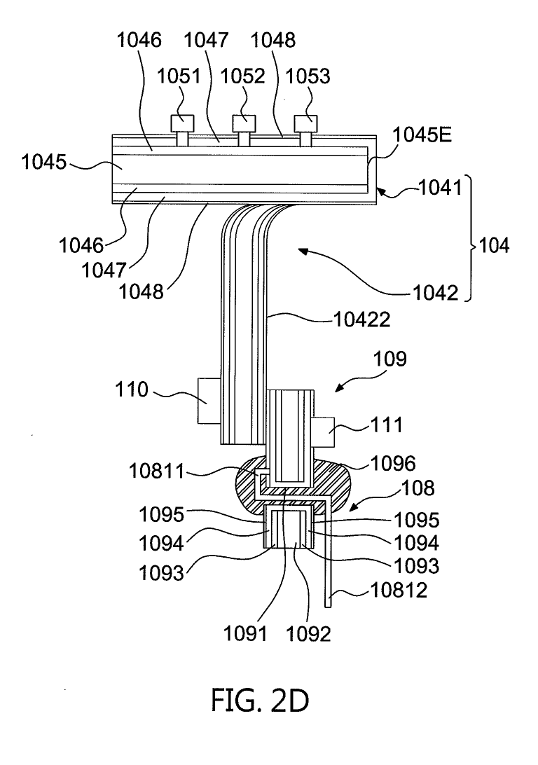

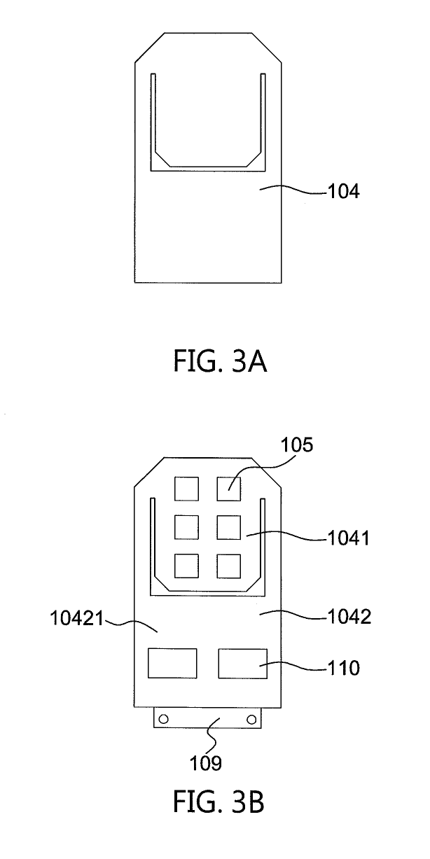

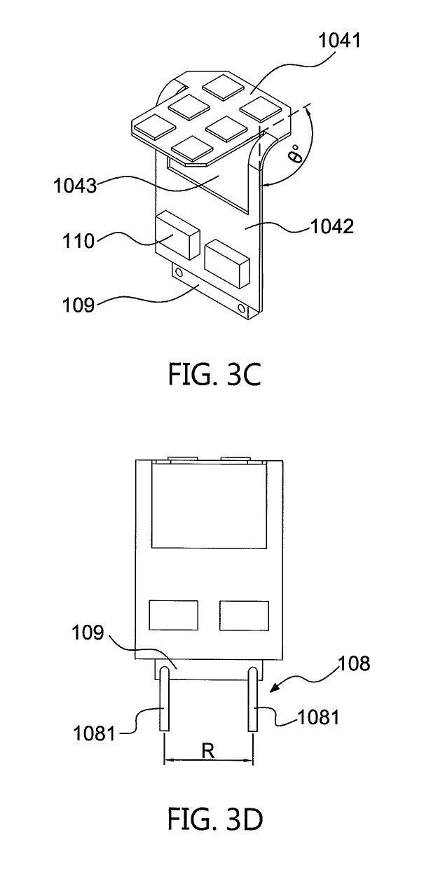

FIGS. 2A-2D illustrate the integrated board 104 of a light-emitting device 100 in accordance with first embodiment of the present disclosure. As shown in FIG. 2A, the integrated board 104 has a first part 1041 and a second part 1042 forming an angle θ with the first part 1041, wherein 0°<θ<180°. The integrated board 104 is of one-piece, and the first part 1041 has a thickness substantially the same as that of the second part 1042, wherein a range of the thickness is between 0.1 mm˜1.5 mm. Also, the material of the first part 1041 is substantially the same as that of the second part 1042. The integrated board 104 further has a bridge part 1043 bridging the first part 1041 and the second part 1042, and the bridge part 1043 is in a form of arms. A hole 1044 is circumscribed by the first part 1041, the second part 1042, and the bridge part 1043, and a shape of the hole 1044 is complementary to a shape of the first part 1041, for example, a rectangle. In the present embodiment, the second part 1042 and the first part 1041 may form a T-shape or a right angle (θ=90 degree), but it is not limited. The plurality of light-emitting elements 105 is disposed on the first part 1041 and a connection type of the plurality of light-emitting elements 105 can be a series connection, a parallel connection or a series-parallel connection. However, the first part 1041 may be wrapped by the filler 107 in the present embodiment(as shown in FIG. 1B), or the first part 1041 may be not wrapped by the filler 107 in other embodiment.

FIG. 2B is a front view of FIG. 2A and FIG. 2C is a back view of FIG. 2A. As shown in FIGS. 2B-2C, the light emitting device 100 further comprises a connecting board 109, a first circuit element 110 and a second circuit element 111, which are arranged on the second part 1042 of the integrated board 104. The second part 1042 has a first side 10421 and a second side 10422 opposite to the first side 10412. The first circuit element 110 is arranged on the first side 10411 and electrically connects to the plurality of light-emitting elements 105. In the present embodiment, the first circuit element 110 comprises a bridge rectifier 1101 and a resister 1102. In other embodiments, the first circuit element 110 may comprise a capacitor, an inductor, a thermally sensitive resister or an integrated circuit (IC), wherein the thermally sensitive resister comprises a positive temperature coefficient type or a negative temperature coefficient type. The connecting board 109 arranged on the second side 10422 of the second part 1042 and has two connecting-holes 1091 located outside the integrated board 104 and without overlapping the integrated board 104. The second circuit element 111 is arranged on the connecting board 109, over the connecting-holes 1091 and electrically connects to the plurality of the light emitting element 105. In the present embodiment, the second circuit element 111 comprises two capacitors 1111, 1112 and a resistor 1113. In other embodiments, the second circuit element 111 may comprise an inductor, a thermally sensitive resister or an integrated circuit(IC), wherein the thermally sensitive resister comprises a positive temperature coefficient type or a negative temperature coefficient type.

As shown in 2D, the integrated board 104 is a multi-layer structure and comprises a supporting layer 1045, two insulating layers 1046 formed on two opposite surfaces of the supporting layer 1045, two patterned and electrically conductive layers 1047 formed on the insulating layers 1046, and two insulting reflective layers 1048 formed on the patterned and electrically conductive layers 1047. The light-emitting elements 1051, 1052, 1053 are fixed on one surface of the patterned and electrically conductive layer 1047, wherein the light-emitting elements 1051, 1052, 1053 may connect in series or parallel. The connecting board 109 is a multi-layer structure and comprises a supporting layer 1092, two insulating layers 1093 formed on two opposite surfaces of the supporting layer 1092, two patterned and electrically conductive layers 1094 formed on the insulating layers 1093, and two insulting reflective layers 1095 formed on the patterned and electrically conductive layers 1094. In other embodiments, the connecting board 109 may be without the insulating layers 1093, so that the patterned and electrically conductive layers 1094 directly formed on the supporting layer 1092. The connecting board 109 connects to the second side 10422 of the second part 1042 and a part of the connecting board 109 extends out of the integrated board 104. One of the patterned and electrically conductive layers 1094 of the connecting board 109 joins and electrically connects to one of the patterned and electrically conductive layers 1047 of the integrated board 104. The patterned and electrically conductive layers 1047 is also formed on an edge 1045E so that the connecting board 109 further electrically connects to the light-emitting elements 1051, 1052, 1053. The second circuit element 111 is formed on a side of the connecting board 109 opposite to the integrated board 104 and the two connecting-holes 1091 pass through the connecting board 109. Similarly, the patterned and electrically conductive layers 1094 is formed on internal surfaces of the connecting-holes 1091 in order to electrically connect to the patterned and electrically conductive layers 1047 of the integrated board 104. One of the pins 1081 of the electrically connecting element 108 has a first end 10811 and a second end 10812, wherein the first end 10811 passes through the connecting-hole 1091 and fixed on the connecting board 109 by an electrically conductive material 1096, such as solder or silver paste, and then the electrically connecting element 108 electrically connects to the first circuit element 110, a second circuit element 111, and the light-emitting elements 1051, 1052, 1053. The second end 10812 is used to electrically connect to the external circuit, like power supply (not shown). The supporting layer 1045 is made of a flexible metal material, such as a Cu, Al. The ductility of the flexible metal material r is in a range of 0.2 mm to 2 mm, wherein r is the minimum bending radius to measure the material flexibility. The withstand voltage of the flexible metal material is more than 1 Kv. The heat transfer coefficient of the flexible metal material is more than 2 W. The supporting layer 1092 comprises an insulating material, such as epoxy, fiberglass, or Al₂O₃. The insulating layers 1046, 1093 comprise epoxy or silicone. The patterned and electrically conductive layers 1047, 1094 comprise Cu, Ni, Au, Sn. The insulting reflective layers 1048, 1095 comprises white paint or ceramic ink.

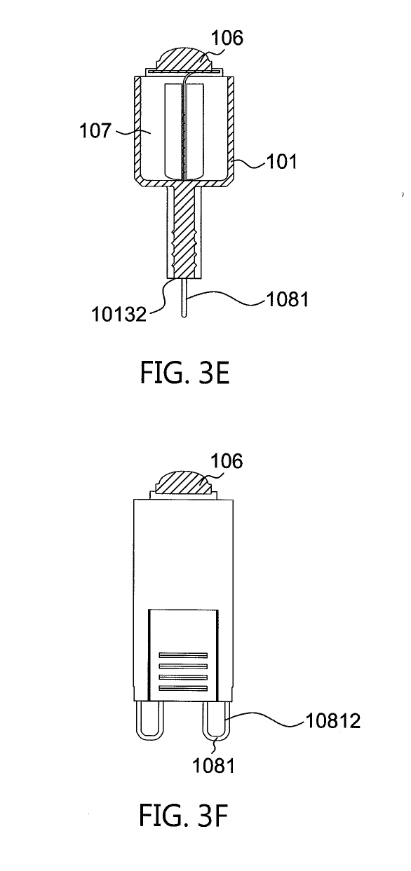

FIGS. 3A˜3H illustrates a fabricating method of a light-emitting device in accordance with the first embodiment of the present disclosure. Fabricating steps of the light-emitting device 100 of present embodiment is as follows: firstly, providing the integrated board 104 (as shown in FIG. 3A); then, by surface mount technology or dual in-line package to form the plurality of light-emitting element 105 on the first part 1041 of the integrated board 104, the first circuit element 110 on the first surface 10421 of second part 1042, the connecting board 109 on the second surface 10422 of the second part 1042 (as shown in FIG. 3B), and the second circuit element 111 on the connecting board 109 (as shown in FIG. 2C); secondly, deflecting the integrated board 104 to form a deflecting region as the bridge part 1043, which the first part 1041 and the second part 1042 are on the opposite side of the bridge part 1043, and form the angle θ, wherein 0°<θ<180° (as shown in FIG. 3C); moreover, forming an electrically connecting element 108 into the connecting board 109 to form an assembly of the integrated board 104, the connecting board 109, the first circuit element 110, the second circuit element 111, and the electrically connecting element 108, wherein the electrically connecting element 108 has two pins 1081 and a minimum distance R between arises of two pins 1081 is a range of 4˜12 millimeter (as shown in 3D). In other embodiments, the step of forming an electrically connecting element 108 can be before deflecting the integrated board 104.

As shown in FIGS. 3E˜3G, after forming the assembly of FIG. 3D, the next fabricating steps are covering the cover 106 on the plurality of light-emitting elements 105 and arranging the assembly with cover 106 into the housing 101, so that the pins 1081 pass through the bottom surface 10132 of the housing 101 and extend out of the housing 101; then, bending the pins 1081 to make the second end 10812 of the pins 1081 extend towards the cover 106, and then filling the filler 107 in the space 1012 of the housing 101; finally, covering the fastener 102 on the integrated board 102 and arranging the lens on the fastener 102 and the cover 106 to complete the light emitting device 100.

In the present embodiment, the integrated board is a fixable material and has two parts for arranging the plurality of light-emitting elements and the circuit elements without soldering or other complicatedly joining methods in order to reduce manpower, costs and manufacturing time. Furthermore, the supporting layer of the integrated board made of metal material can guide the heat graduating from the plurality of light-emitting elements into the assembly to increase the heat dissipating effect. It should be notice that a size of the angle θ is based on the requirement of products.

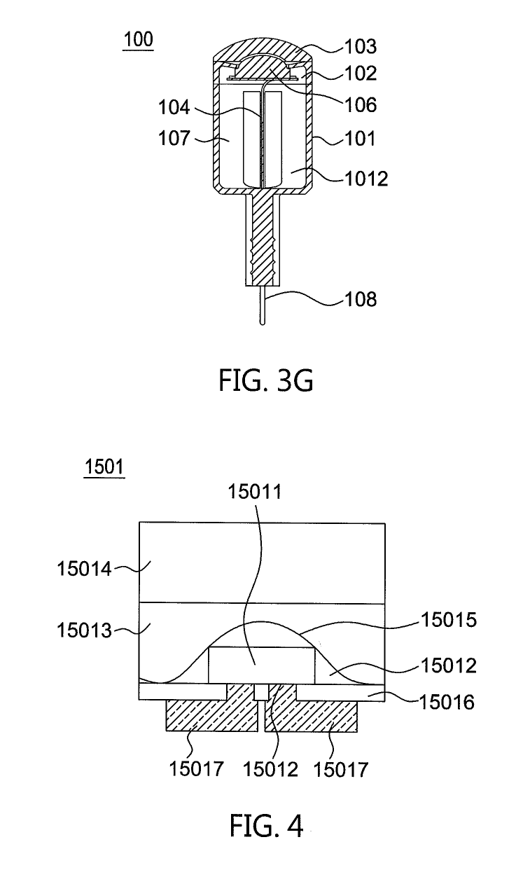

FIG. 4 illustrates a cross-section of a light-emitting element 1501, 1502 or/and 1053 of a light-emitting device in accordance with the first embodiment of the present disclosure. The light-emitting element 1051 comprises a light-emitting diode 10511, a first transparent part 10512 arranged on the light-emitting diode 10511, a second transparent part 10513 arranged on the first transparent part 10512, a third transparent part 10514 arranged on the second transparent part 10513, and a wavelength conversion layer 10515 arranged between the first transparent part 10512 and the second transparent part 10513. The light-emitting diodes 10511 comprises a first semiconductor layer, an active layer, and a second semiconductor layer, wherein the first semiconductor layer and the second semiconductor layer may be cladding layers or confinement layers and provide the electrons and holes respectively such that electrons and holes can be combined in the active layer to emit light (not shown). The first semiconductor layer, the active layer and the second semiconductor layer comprise a III-V semiconductor material, such as AlₓIn_{y}Ga_{(1-x-y)}N or AlₓIn_{y}Ga_{(1-x-y)}P, wherein 0≦x, y≦1 and (x+y)≦1. Depending on a material of the active layer, the light-emitting diode 10511 may graduate red light having a range of a wavelength is between 610 nm˜650 nm, green light having a range of a wavelength is between 530 nm˜570 nm, or blue light having a range of a wavelength is between 450 nm˜490 nm. The wavelength conversion layer 10513 can include a yellow phosphor (YAG or TAG), a red phosphor (silicate-based), or both. The light-emitting device 1051 further comprises a reflective layer 10516 disposed on a surface 10512S of the first transparent part 10512 and a pair of electric covering the reflective layer 10516 and a part of the surface 10512S of the first transparent part 10512.

The foregoing description has been directed to the specific embodiments of this invention. It will be apparent; however, that other alternatives and modifications may be made to the embodiments without escaping the spirit and scope of the invention.

What is claimed is:

1. A light-emitting device, comprising:
an integrated board having a first part and a second part forming an angle other than zero with the first part; and
a light-emitting element disposed on the first part.

2. The light-emitting device of claim 1, wherein the first part has a thickness substantially the same as that of the second part.

3. The light-emitting device of claim 1, wherein the integrated board is of one-piece.

4. The light-emitting device of claim 1, wherein the integrated board further has a bridge part bridging the first part and the second part, and the bridge part is in a form of arms.

5. The light-emitting device of claim 1, further comprising a hole circumscribed by the first part, the second part, and the bridge part.

6. The light-emitting device of claim 5, wherein a shape of the hole is complementary to a shape of the first part.

7. The light-emitting device of claim 1, wherein the second part and the first part form a T-shape or a right angle.

8. The light-emitting device of claim 1, further comprising a housing having a body surrounding the integrated board and a base narrower than the body.

9. The light-emitting device of claim 8, further comprising a filler filling a space within the body.

10. The light-emitting device of claim 9, wherein the integrated board is wrapped by the filler.

11. The light-emitting device of claim 10, wherein the second part is not wrapped by the filler.

12. The light-emitting device of claim 8, further comprising an electrically connecting element passing through a through-hole of the base.

13. The light-emitting device of claim 9, wherein the filler comprising a thermally conductive material.

14. The light-emitting device of claim 1, further comprising a cover covering the light-emitting element.

15. The light-emitting device of claim 1, further comprising a fastener covering the integrated board.

16. The light-emitting device of claim 14, further comprising a fastener having an opening exposing the cover, and/or a lens covering the fastener and the cover.

17. The light-emitting device of claim 1, further comprising a first circuit element arranged on the second part and electrically connects to the light-emitting element.

18. The light-emitting device of claim 17, further comprising a second circuit element arranged on an opposite side of the second part to the first circuit element and electrically connecting to the light-emitting element.

19. The light-emitting device of claim 18, further comprising a connecting board connecting to the second part, a second circuit element arranged on the connecting board and electrically connecting to the light-emitting element, and/or an electrically connecting element fixed on the connecting board and electrically connecting to the first circuit element.

20. A method for manufacturing a light-emitting device, comprising:
providing an flexible integrated board having two parts;
forming a light-emitting element on one of the two parts of the flexible integrated board;
forming a circuit element on another of the two parts of the flexible integrated board; and
deflecting the flexible integrated board such that two parts of the flexible integrated board on opposite sides of a deflected region form an angle other than zero.
